(19) United States
(12) Patent Application Publication
(10) Pub. No.: US 2007/0196160 A1
(43) Pub. Date: Aug. 23, 2007

(54) Tips for ball-point pens, roller ball pens or gel ink roller ball pens

(75) Inventor: Yasunori Nakatani, Osaka-shi (JP)

Correspondence Address: HAMRE, SCHUMANN, MUELLER & LARSON, P.C., P.O. BOX 2902, MINNEAPOLIS, MN, 55402-0902, US

(73) Assignee: Sakura Color Products Corporation, Osaka-shi (JP)

(21) Appl. No.: 10/593,201

(22) PCT Filed: Mar. 16, 2005
(86) PCT No.: PCT/JP05/04696

§ 371 Date: Sep. 15, 2006

(30) Foreign Application Priority Data
Mar. 18, 2004 (JP) 2004-078695

(51) Int. Cl. B43K 7/10; B43K 7/00

(52) U.S. Cl. 401/215; 401/209

(57) ABSTRACT

In the present invention, tips for ball-point pens, roller ball pens or gel ink roller ball pens 1, comprising a ball receiving part (1a) and a ball (2) are characterized in that the material of the ball receiving part (1a) is a ferritic stainless steel material which does not contain a lead component as a free machining material and which contains bismuth (Bi) and sulfur (S) as the free machining material and thus, toxicity by the lead component is eliminated, and a machinability required for the ball-point pen tip is realized.

### BACKGROUND OF THE INVENTION

1. Field of the Invention

The present invention relates to tips for ball-point pens, roller ball pens or gel ink roller ball pens in which a ball contacts with a ball seat and is rotatably embraced in a ball-embracing chamber. In more detail, the present invention relates to tips for ball-point pens, roller ball pens or gel ink roller ball pens which improve machinability of a ball receiving part without containing a lead component as a free machining material thereby enhancing a rotation of a ball.

2. Description of the Prior Art

Conventionally, such a structure of tips for ball-point pens, roller ball pens or gel ink roller ball pens is known in which a ball is rotatably embraced in a ball-embracing chamber with a part of a ball protruded from a tip end portion of a ball receiving part by a tip edge portion of a ball receiving part which is caulked inward of the ball receiving part and a ball seat. Such tips for ball-point pens, roller ball pens or gel ink roller ball pens require fine precision machining. For fine precision machining, machinability of steel should be improved and the steel with about 0.1 to 0.3 wt % of lead added is used.

For example, a ferritic stainless steel material which contains about 20 wt % of chrome (for example, in item number DSR6F manufactured by Daido Steel Co., Ltd., about 0.1 to 0.3 wt % of lead is added), that is, a material which is so-called 20 Cr material (hereinafter, simply called as 20 Cr material)is being used.

In order to improve strength of the above mentioned 20 Cr material, tips for ball-point pens, roller ball pens or gel ink roller ball pens which use a silicon-added ferritic stainless steel material is disclosed (Patent Document 1: Japanese Patent Laid-Open Publication No. Hei 10-203075). However, with the increased awareness of environmental issues, toxicity of lead is acknowledged as a problem and in tips for ball-point pens, roller ball pens or gel ink roller ball pens, usage of lead should be decreased.

However, when lead which was generally added for improving machinability is removed, a material itself becomes hardened and at the same time, machinability is lost. Thus, in performing machining work, dimensional working accuracy gets worse and therefore, prescribed dimension cannot be realized, a machined surface gets rough, more burrs are generated, or a life of a processing edge tool (tool) gets extremely short. Further, operation rate of production machinery gets worse and therefore, tips for ball-point pens, roller ball pens or gel ink roller ball pens with low price and high quality cannot be provided. Moreover, a problem of deterioration in writing performance arises including deterioration in writing condition caused by increased resistance at the time of rotation at a contact surface with a ball. Actually, simply not adding lead of a ferritic stainless steel material cannot satisfy conventional quality and since the ball does not rotate smoothly, it can not be employed.

The object of the present invention is to provide tips for ball-point pens, roller ball pens or gel ink roller ball pens using a ferritic stainless steel material from the environmental view point, having production efficiency equivalent to that of a conventional ball-point pen tip work process, and provided with stable quality with good writing condition.

### SUMMARY OF THE INVENTION

In the present invention, tips for ball-point pens, roller ball pens or gel ink roller ball pens comprise a ball receiving part and a ball, wherein a material of the above mentioned ball receiving part does not contain a lead component as a free machining material but is a ferritic stainless steel material which contains bismuth (Bi) as a free machining material. As a result, toxicity by lead can be eliminated thereby enabling cutting as tips for ball-point pens, roller ball pens or gel ink roller ball pens. Here, the preferable range of the content of the aforementioned bismuth (Bi) is within 0.01 to 0.5 wt % with respect to the ferritic stainless material which makes up the above mentioned ball receiving part.

In addition, it is preferable that in the ball-point pen tip, the material of the above mentioned ball receiving part is a ferritic stainless steel which further contains sulfur (S) as a free machining material. By this, machinability is further improved thereby enhancing production efficiency as well as improving writing condition of tips for ball-point pens, roller ball pens or gel ink roller ball pens and stabilizing their quality. Here, it is preferable that the content of the above mentioned sulfur (S) is within the range of 0.1 to 0.5 wt % with respect to the ferritic stainless material which makes up the above mentioned ball receiving part.

Further, as a material of the above mentioned ball receiving part, ferritic stainless steel material which contains sulfide inclusions, manganese (Mn), molybdenum (Mo), and chrome (Cr) as a free machining material can also be used. As a material of the above mentioned ball receiving part, the ferritic stainless steel material which makes up the above mentioned ball receiving part preferably contains 1.0 to 1.5 wt % of manganese (Mn), 1.5 to 2.0 wt % of molybdenum (Mo),and 19 to 21 wt % of chrome (Cr).

In addition, the ball-point pen tip can be prepared in which a material of the ball receiving part does not contain a lead component as a free-cutting material but is a ferritic stainless steel material which contains at least sulfur (S) and bismuth (Bi) as the free-cutting material, wherein the above mentioned ferritic stainless steel material contain not greater than 0.05 wt % of carbon (C), not greater than 1.0 wt % of silicon (Si), not greater than 2.0 wt % of manganese (Mn), not greater than 0.05 wt % of phosphor (P), 0.25 to 0.35 wt % of sulfur (S), 19 to 21 wt % of chrome (Cr), not greater than 2.0 wt % of molybdenum (Mb), not greater than 0.05 wt % of tellurium (Te), and not greater than 0.05 wt % of bismuth (Bi). As a result, machinability can further be improved thereby enhancing production efficiency as well as further improving writing condition of tips for ball-point pens, roller ball pens or gel ink roller ball pens and further stabilizing their quality.

Further, shapes of ball-point pens include any type of ball-point pens used as writing tools such as conventional shapes of ball-point pens for oily inks and for aqueous inks.

### BRIEF DESCRIPTION OF THE DRAWINGS

FIG. 1 is a longitudinal section view of a tip end portion of a receiving part of a tip for ball-point pens, roller ball pens or gel ink roller ball pens of the present invention.

FIG. 2 is a section view taken along the line B-B′ in FIG. 1.

FIG. 3 is a graph showing wear amount in a ball receiving part with a ball diameter of 0.5 mm by a rotation of a ball after writing 500 m.

FIG. 4 is a graph showing wear amount in a ball receiving part with a ball diameter of 0.4 mm by a rotation of a ball after writing 500 m.

### DESCRIPTION OF THE PREFERRED EMBODIMENTS

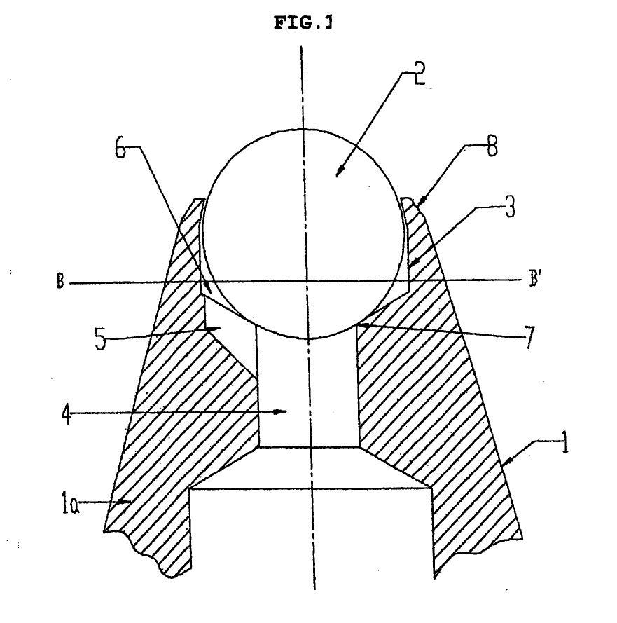

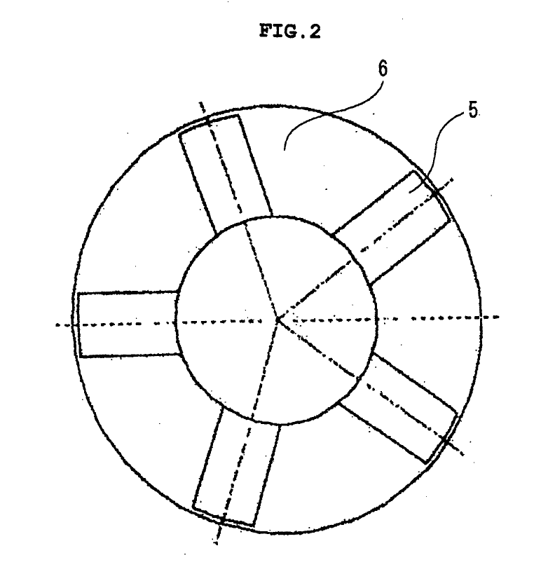

The embodiment of the present invention by the general shape of the receiving part of the ball-point pen tip is hereby explained using FIGS. 1 and 2. A ball receiving part 1a is formed using ferritic stainless steel which does not contain lead but contains sulfide inclusions, silicon, bismuth, manganese, and molybdenum, and about 20 wt % of chrome. On a ball seat 7 of a bottom wall 6 of a ball embracing chamber 3, an ink passage hole 4 and radial grooves 5 which extends radially from said ink passage hole 4 are provided, thereafter caulking a tip edge portion 8 of a ball receiving part, letting a part of the ball 2 protrude outward of the tip edge portion 8 of a ball receiving part, rotatably embraced. Lastly, a ball 2 is hammered.

As a substitute of not adding lead, bismuth is added in a small amount to enhance machinability and further, sulfur which is effective in enhancing machinability is added twice as much as the conventional one. By this, machinability has been enhanced and rotation of a ball has become smooth.

As balls, tungsten carbide ultra-high-hardened balls, stainless balls, resin balls such as polyacetal and the like, ceramic balls such as silica, alumina, zirconia, silicon carbide, silicon nitride, and the like can be used.

### EXAMPLE 1

Examples of the present invention are hereby explained using drawings. The original shape of a ball receiving part 1a (not illustrated) is manufactured using ferritic stainless steel which has compound of the main components as shown below and which contains about 20 wt % of chrome. Next, by machining work, a ball 2 whose diameter is 0.5 mm made of alumina based ceramic material is formed in a ball embracing chamber 3 in a way that is capable of embracing the ball, followed by providing an ink passage hole 4 at the center of a bottom wall 6 of the ball embracing chamber 3 and providing radial grooves 5 which extend radially from the above mentioned ink passage hole 4. Then, the ball 2 is inserted in the ball embracing chamber 3 and is brought in to contact with the bottom wall 6 there by caulking a tip edge portion 8 of a ball receiving part, letting a part of the ball 2 protrude outward of the tip edge portion 8 of the above mentioned ball receiving part, and rotatably embracing. Next, a protruded part of a ball is hammered thereby forming a ball seat 7 in which a contacted portion by hammering is made to be a ball shape. Although the embodiment of hammering varies depending on the kinds of ball receiving parts 1a, in the present invention, hammering was applied by 5 μm vertically.

| | |
|---|---|
| Chrome | 20.06 wt % |
| Carbon | 0.01 wt % |
| Silicon | 0.47 wt % |
| Manganese | 1.25 wt % |
| Phosphor | 0.02 wt % |
| Sulfur | 0.29 wt % |
| Molybdenum | 1.79 wt % |
| Bismuth | 0.05 wt % |
| Tellurium | 0.04 wt % |

### EXAMPLE 2

By the same method as in Example 1, a tip for ball-point pens, roller ball pens or gel ink roller ball pens of Example 2 was manufactured in which a ball diameter was changed into φ0.4 mm.

### COMPARATIVE EXAMPLE

As Comparative Examples 1 and 2, a ball receiving part with the same diameter of that of Examples 1 and 2 was manufactured using ferritic stainless steel which has compound of the main components as shown below and which contains about 20 wt % of chrome thereby manufacturing tips for ball-point pens, roller ball pens or gel ink roller ball pens as in Examples 1 and 2.

| | | |
|---|---|---|
| Chrome | 19.93 | wt % |
| Carbon | 0.005 | wt % |
| Silicon | 0.43 | wt % |
| Manganese | 1.22 | wt % |
| Phosphor | 0.029 | wt % |
| Sulfur | 0.27 | wt % |
| Molybdenum | 1.77 | wt % |
| Lead | 0.015 | wt % |
| Tellurium | 0.027 | wt % |

Five aqueous gel ink roller ball pens were manufactured, respectively, preparing gel ink roller ball pen refills by connecting each ball-point pen tip with ink cylinders in which aqueous gel inks for the pens (model numberPGBE05 manufactured by Sakura Color Products Corporation) interposing a holder were filled. Regarding each aqueous gel ink roller ball pen, tests and evaluations were conducted based on the following method.

Continuous writing test: Under the condition of a writing angle of 65°, a load of 100 g (a load equivalent to writing pressure at the time of writing on a copy slip), and writing speed of 4.2 m/min, wear amount (dented amount) of a ball seat after writing spirally 500 m was measured by a microscope.

Evaluation on written marks: ∘ for the condition where good written marks can be obtained without any broken traces of writing and the like or without any changes in density of written marks to the last in not less than the 4 pens out of 5.

X for the condition where there are broken traces of writing and the like or some changes in density of written marks in not less than the 1 pen out of 5.

Evaluation on writing condition: Smoothness of writing feeling is evaluated by sensory test by handwriting.

Evaluation: ∘ for smooth writing condition without ink slack.

X for heavy writing condition with ink slack.

Machinability: machined scraps are judged by visual observation.

Evaluation: ∘ for the condition where scraps are in fine powders.

X for the condition where scraps become helical.

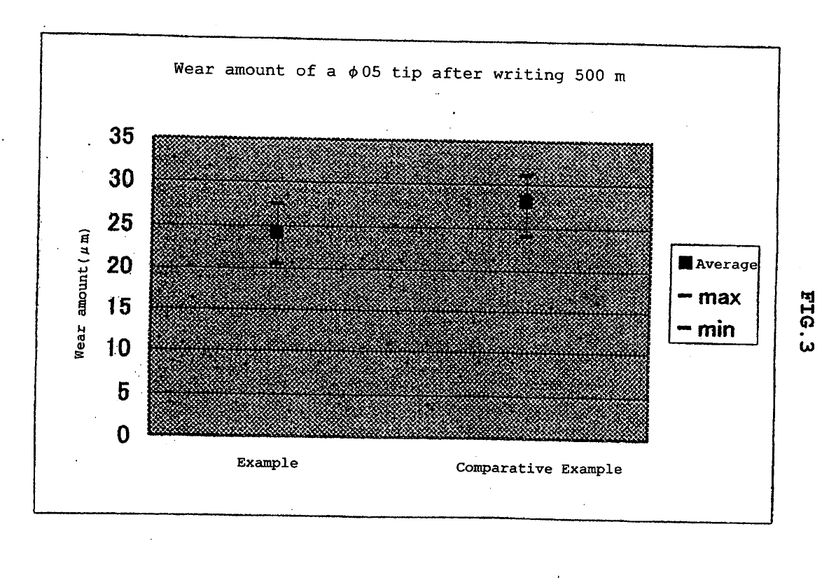

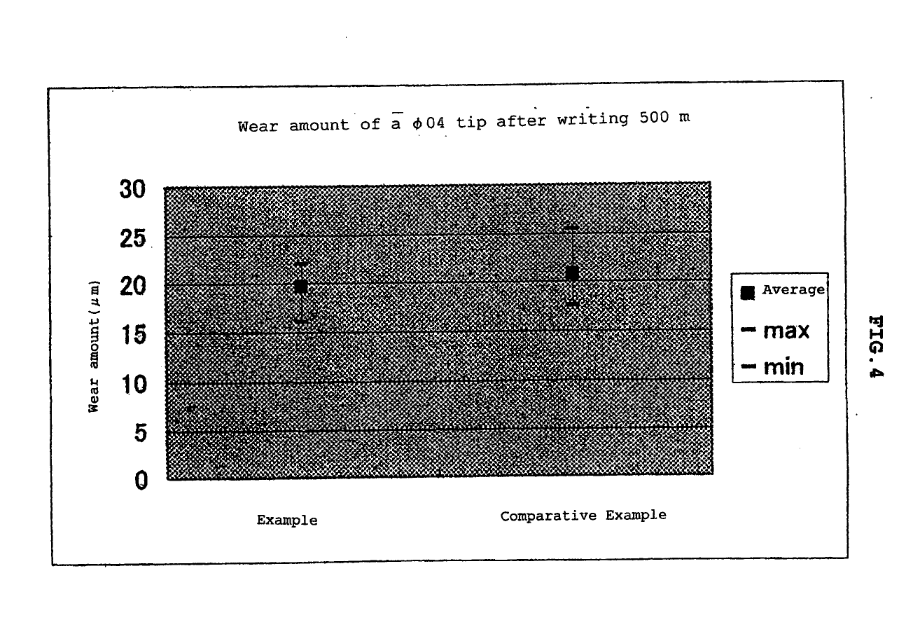

The results are as shown in table 1. Graphs showing wear amount in a ball receiving part of φ 0.4 mm and in a ball receiving part of φ 0.5 mm after writing 500 m are also shown in FIGS. 3 and 4.

TABLE 1

| | | | | | | | | | | Evaluation | | | |
|---|---|---|---|---|---|---|---|---|---|---|---|---|---|
| | | Ball diameter | Addition of | Wear amount after writing 500 m | | | | | Average | on wear | Written | Writing | |
| | | (mm) | lead | (μm) | | | | | (μm) | amount | mark | condition | Machinability |
| Example | 1 | 0.5 | 0% | 27 | 23.5 | 22 | 20.5 | 27.5 | 24.1 | ◯ | ◯ | ◯ | ◯ |
| | 2 | 0.4 | 0% | 22 | 16 | 18.5 | 22 | 19.5 | 19.6 | ◯ | ◯ | ◯ | ◯ |
| Comparative | 1 | 0.5 | 0.015% | 24 | 30 | 31 | 28 | 27 | 28 | ◯ | ◯ | ◯ | ◯ |
| Example | 2 | 0.4 | 0.016% | 18.5 | 17.6 | 19.5 | 22.5 | 25.5 | 20.7 | ◯ | ◯ | ◯ | ◯ |

Examples 1 and 2 and Comparative Examples 1 and 2 showed that in a test of writing property, blurring of traces of writing or non-uniform density of written marks by a dent of a ball-seat or wear were not generated. Further, no problem occurred in every Example and Comparative Example with regard to machinability. Therefore, in Examples, the same performance as that of Comparative Examples could be retained without containing a lead component.

On the other hand, in Comparative Example 1, wear to a ball seat was greater than that of Example 1 when conducting a test of writing 500 m (FIG. 3). Further, in Comparative Example 2, wear to the ball seat was almost the same as that of Example 2 when conducting a test of writing 500 m (FIG. 4).

### Effect of the Invention

Although tips for ball-point pens, roller ball pens or gel ink roller ball pens of the present invention use a ferritic stainless steel material which does not contain lead from the environmental view point, by increasing the additional amount of bismuth and further, that of sulfur, they showed the same machinability and wear as tips for ball-point pens, roller ball pens or gel ink roller ball pens as those of a ferritic stainless steel material which contains lead. Therefore, the tips of the present invention can provide enhanced production efficiency in tips for ball-point pens, roller ball pens or gel ink roller ball pens work process, can provide stable quality with good writing condition, and can be used as a safe one taking account of environment.

### INDUSTRIAL APPLICABILITY

The tips of the present invention can be used for the pens regardless of whether they are aqueous or oily. Moreover, the tips of the present invention can be used as the tips capable of improving machinability of a ball receiving part without containing a lead component as a free machining material thereby improving a rotation of a ball.

What is claimed is:

1. Tips for ball-point pens, roller ball pens or gel ink roller ball pens comprising a ball receiving part and a ball, wherein a material of the above mentioned ball receiving part does not contain a lead component as a free machining material but is a ferritic stainless steel material which contains bismuth (Bi) as a free machining material.

2. The tips for ball-point pens, roller ball pens or gel ink roller ball pens as set forth in claim 1, wherein a material of the above mentioned ball receiving part is a ferritic stainless steel material which includes sulfur (S) as a free machining material.

3. The tips for ball-point pens, roller ball pens or gel ink roller ball pens as set forth in claim 2, wherein a material of the above mentioned ball receiving part is a ferritic stainless steel material which includes sulfide inclusions, manganese (Mn), molybdenum (Mo), and chrome (Cr) as a free machining material.

4. Tips for ball-point pens, roller ball pens or gel ink roller ball pens comprising a ball receiving part and a ball, wherein a material of the above mentioned ball receiving part does not contain a lead component as a free machining material but is a ferritic stainless steel material which contains bismuth (Bi) as a free machining material and said ferritic stainless steel material contains not greater than 0.05 wt % of carbon (C), not greater than 1.0 wt % of silicon (Si), not greater than 2.0 wt % of manganese (Mn), not greater than 0.05 wt % of phosphor (P) 0.25 to 0.35 wt % of sulfur (S), 19 to 21 wt % of chrome (Cr), not greater than 2.0 wt % of molybdenum (Mb), not greater than 0.05 wt % of tellurium (Te), and not greater than 0.05 wt % of bismuth (Bi).
